(19) United States
(12) Patent Application Publication
(10) Pub. No.: US 2005/0187792 A1
(43) Pub. Date: Aug. 25, 2005

(54) Optical prescription card

(75) Inventor: W. Jack Harper, Evergreen, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BSI2000, Inc., Lakewood, CO (US)

(21) Appl. No.: 11/056,828

(22) Filed: Feb. 10, 2005

Related U.S. Application Data
(63) Continuation-in-part of application No. 10/726,971, filed on Dec. 2, 2003.
Application No. 10/726,971 is a continuation-in-part of application No. 09/454,717, filed on Dec. 6, 1999, now Pat. No. 6,775,774.
(60) Provisional application No. 60/543,597, filed on Feb. 10, 2004.

(51) Int. Cl. G06F 17/60

(52) U.S. Cl. 705/2

(57) ABSTRACT

According to the invention, a method for distributing drug interaction information for pharmacological compounds is disclosed. In one step, a request is received for a pharmacological compound for administration to a party. A list is received that includes a plurality of other pharmacological compounds associated with the party. A listing of possible drug interactions related to at least one of the pharmacological compound or the plurality of other pharmacological compounds is read from an optical card. It is determined if the pharmacological compound is contraindicated from the listing of possible drug interactions. A subset of the listing of possible drug interactions relevant to use of the pharmacological compound with the plurality of other pharmacological compounds is printed.

This application is a non-provisional of U.S. Patent Application Ser. No. 60/543,597 filed on Feb. 10, 2004; this application is also a continuation-in-part of U.S. patent application Ser. No. 10/726,971, filed on Dec. 2, 2003, which is a continuation-in-part U.S. Pat. No. 6,775,774 filed on Dec. 6, 1999; which are all incorporated by reference in their entirety for all purposes.

### BACKGROUND OF THE INVENTION

The present embodiments of the invention relate generally to optical cards. More particularly, one embodiment of the invention relates to use of an optical card in dispensing of health care.

There is a great need to improve our health care systems while protecting patient privacy. Often medical personnel do not have access to a patient's medical records in an emergency. This is especially true for a patient that is unconscious or otherwise unable to communicate the details of their medical history. Medic alert bracelets are one attempt to solve this problem.

Another attempted solution is to have medical information in a database accessible to medical personnel. A database such as this contains information on patients that is aggregated from a number of sources. There are privacy concerns that these databases could be accessed by hackers, employers or insurers to the detriment of the patient.

For many reasons, computer systems for many health care providers are not interconnected. For example, the systems may be incompatible or isolated from networks to protect patient privacy. When a patient is referred from a first caregiver to a second caregiver many details do not follow the patient. For example, a doctor may prescribe a non-generic version of a medication because of inside knowledge of problems with the generic equivalent. When a prescription is filled, the pharmacist may substitute the generic equivalent regardless of what the prescription says.

### BRIEF DESCRIPTION OF THE DRAWINGS

The present invention is described in conjunction with the appended figures:

FIG. 1A is a diagram of an embodiment of an optical prescription card;

FIG. 1B is a diagram of another embodiment of the optical prescription card;

FIG. 1C is a diagram of yet another embodiment of the optical prescription card;

FIG. 2A is a block diagram of an embodiment of a multiple care giver system;

FIG. 2B is a block diagram of another embodiment of the multiple care giver system where a pharmacy does not have access to a drug interaction database;

FIG. 2C is a block diagram of yet another embodiment of the multiple care giver system where the pharmacy only has an optical card reader;

FIG. 2D is a block diagram of another embodiment of the multiple care giver system where there are two different drug interaction databases;

FIG. 2E is a block diagram of yet another embodiment of the multiple care giver system where a doctors office maintains a patient database;

FIG. 2F is a block diagram of still another embodiment of the multiple care giver system where the patient database is located remotely;

FIG. 3 is a diagram of an embodiment of a treatment information datastructure;

FIG. 4 is a diagram of an embodiment of a patient information datastructure;

FIG. 5 is a diagram of an embodiment of a regiment information datastructure;

FIG. 6 is a diagram of an embodiment of a treatment information trust chain;

FIG. 7 is a diagram of an embodiment of a medical professional trust chain;

FIG. 8 is a diagram of an embodiment of an identification trust chain;

FIG. 9 is a flow diagram of an embodiment of a process for issuing treatment information by a first medical professional; and

FIG. 10 is a flow diagram of an embodiment of a process for a second medical professional to use the treatment information.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE PREFERRED EMBODIMENT

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

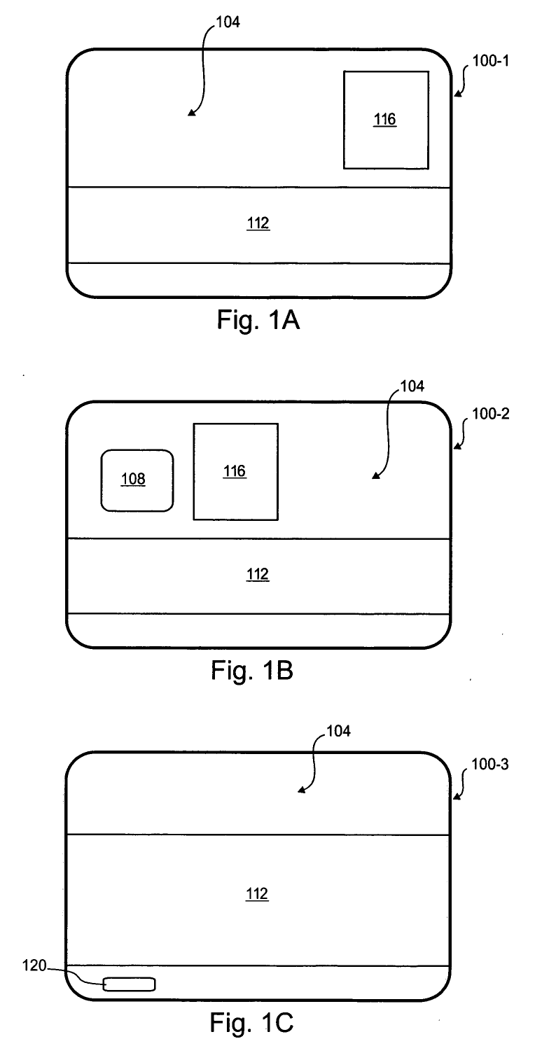

Referring first to FIG. 1A, a diagram of an embodiment of an optical prescription card 100-1 is shown. The optical prescription card 100 carries identification information, medical regimen information and other information related to treatment of a patient. All the information stored on the card can be authenticated as being written by a particular party. The optical prescription card 100 can be configured in any number of ways, but generally serves to transport digital information and authenticate the identity of the cardholder.

This embodiment of the optical prescription card 100-1 includes a cardholder photo 116, an optical storage area 112, and a printed area 104 on one side of the card 100-1. The other side of the card 100-1 could also be used in various embodiments. For example, the optical prescription card 100-1 could include a bar code(s) or other optically recognizable code, a signature block, a magnetic stripe, counterfeiting safeguards, etc. Things such as the picture 116 could be used to authenticate the cardholder or patient's identity. The printed area 104 can include information on the issuer and/or cardholder in printed form.

The optical storage area 112 holds digitized information for various purposes. This embodiment has a capacity of 1.1 megabytes, but other capacities are possible. The optical media is write-once in this embodiment, but other embodiments could be rewritable. Each bit on the write-once optical media can change state only one time. Information written to the card 100-1 can be effectively erased by programming all bits or can be logically erased by indicating to the file system that a file is unusable.

The information in the optical storage area 112 could be used for any number of purposes. For example, the card 100 could include patient medical history (e.g., medical procedures performed, known drug reactions of the patient, treatment regiment or protocol information, gene sequence information on the patient, digital diagnostic scans), drug interaction information; software useful in presenting, analyzing or gathering information; and/or biometric information for authenticating the patient. Any software on the card 100-1 could be in an interpreted language (e.g., ACTIVEX™ or JAVA™), script and/or executable form.

The information is visible to readers, but is sometimes encrypted to prevent unauthorized access. Authorization can be given to the patient, caregiver, and/or others for each individual piece of information. There could be multiple levels of security such that a subset of the information is available to various parties reading the optical health card.

Information on the optical prescription card 100 can be authenticated or not. Authenticated information can be verified as being unmodified by any number of parties in a trust chain. By using certificates, the authenticity of the stored information can be confirmed by a number of parties. Various techniques using various algorithms can be used to confirm authenticity. In some cases, the reader has to confirm authenticity from a wide area network, but in other cases, authenticity can be confirmed without contacting other parties.

With reference to FIG. 1B, a diagram of another embodiment of the optical prescription card 100-2 is shown. This embodiment adds electronics 108 to the optical card 100-2 to add smart card capabilities. The electronics 108 are interfaced with contacts on the surface of the card 100-2. The electronics could include a microprocessor, non-volatile memory, volatile memory, a cryptographic processor, a random number generator, and/or any other electronic circuits. Unlike the optical storage area 112, information stored in the electronics 108 is not discernable without destroying the optical card 100-2. Electronic security measures could be used to protect reading information stored in the electronics 108.

Referring next to FIG. 1C, a diagram of yet another embodiment of the optical prescription card 100-3 is shown. This embodiment uses a larger optical storage area 112 that holds 2.8 megabytes of information. Also, a RFID tag 120 or contactless smartcard is included that can be read by proximity readers. For example, the RFID tag could be read while still in the pocket of the cardholder. This could allow automatically knowing when the optical card 100-3, and the patient by implication, was in the medical office or pharmacy without asking the patient to do anything.

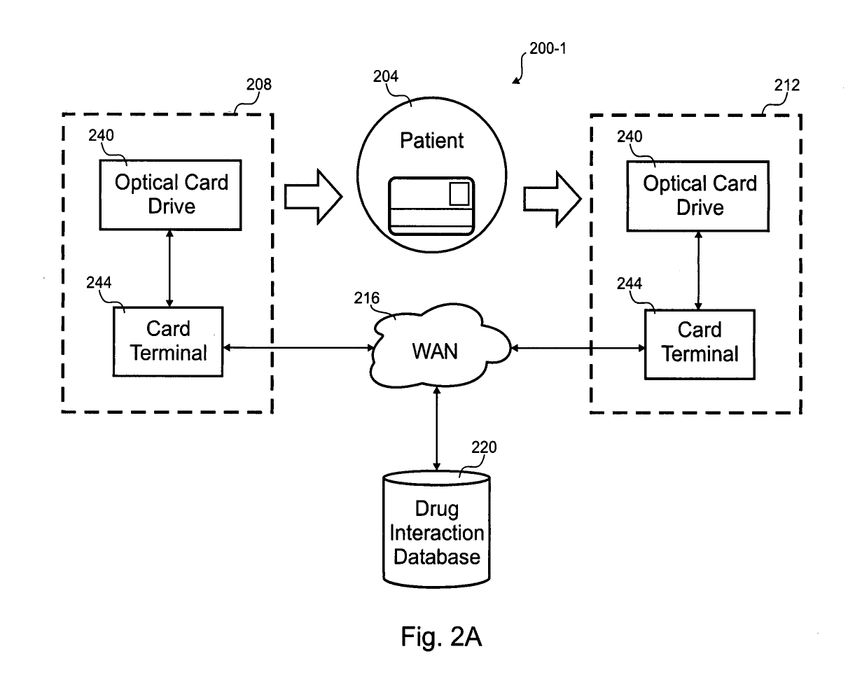

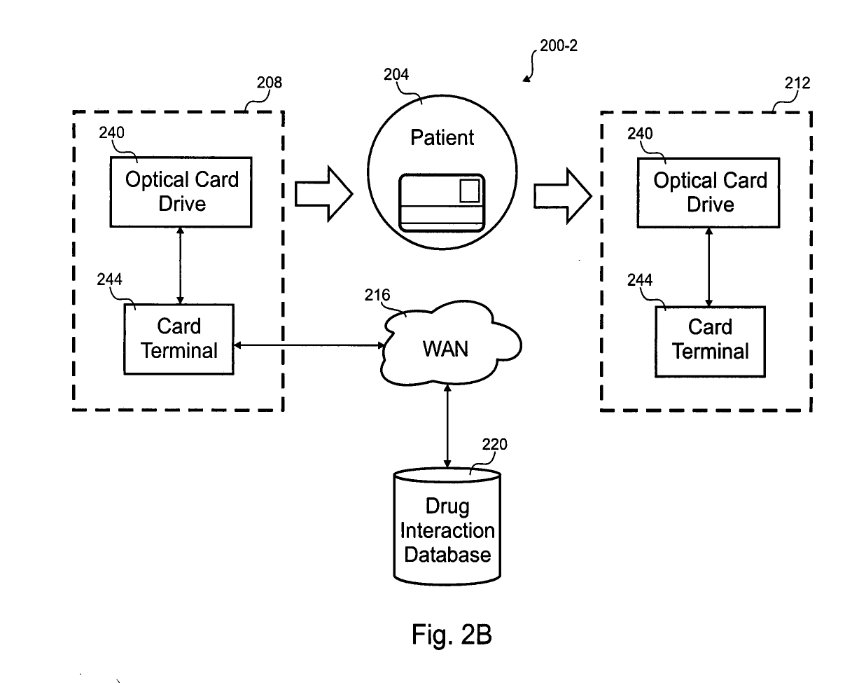

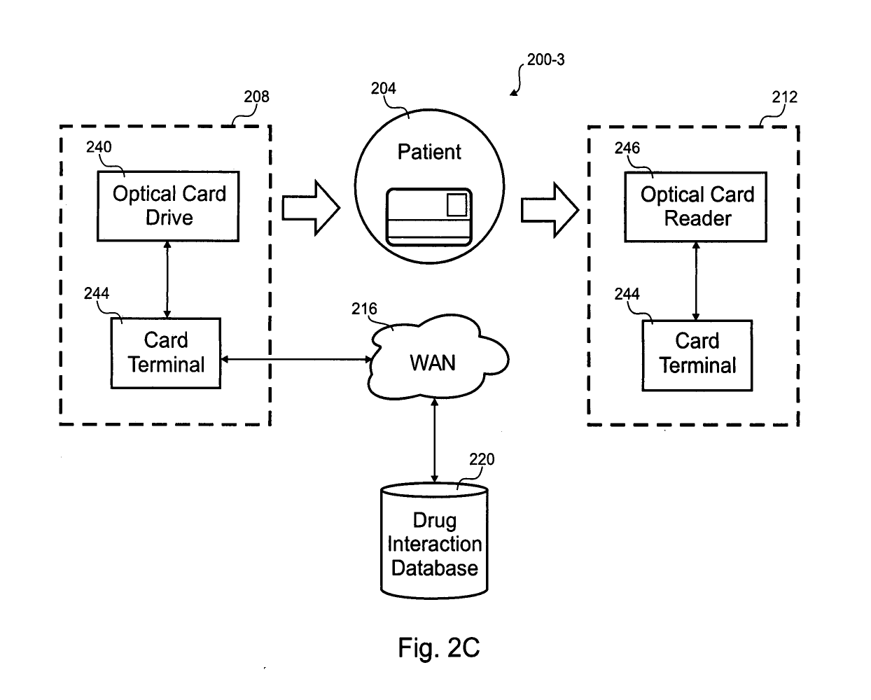

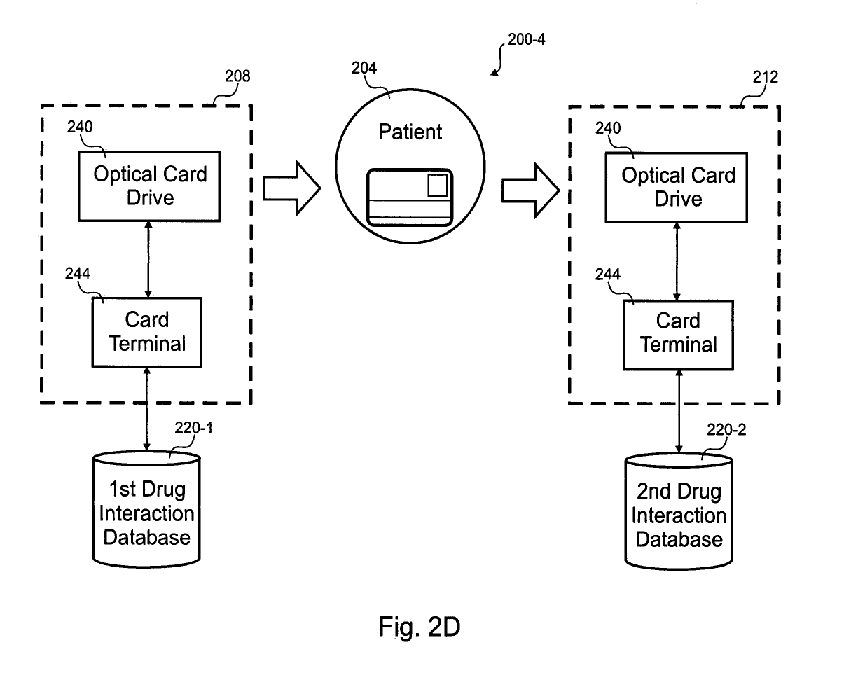

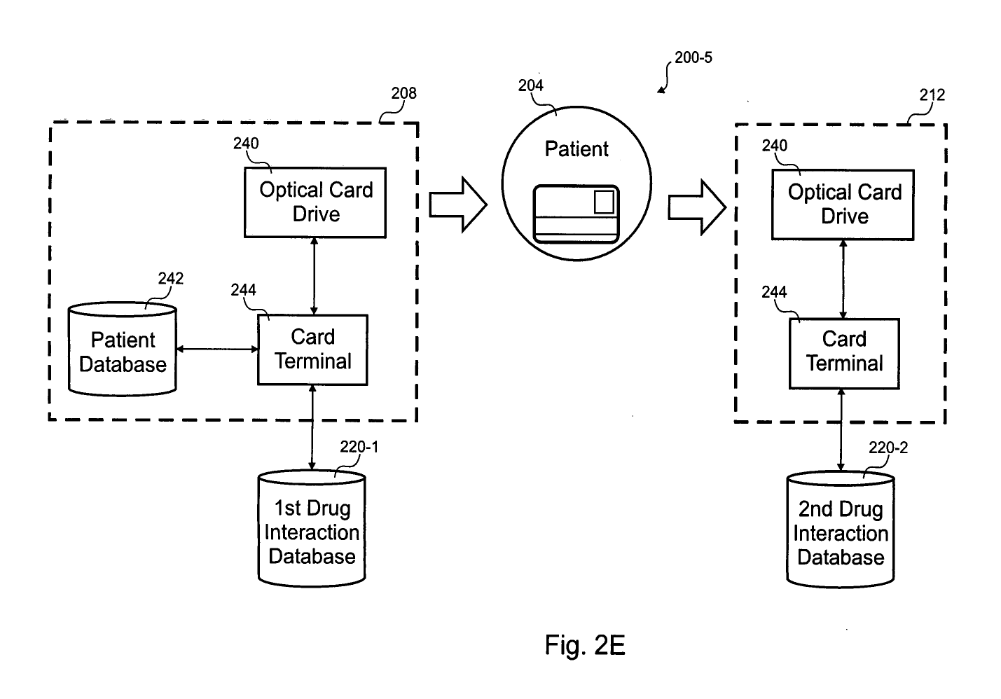

With reference to FIG. 2A, a block diagram of an embodiment of a multiple care giver system 200-1 is shown. In this embodiment, a patient 204 visits a doctors office 208 for a prescription that is filled at the pharmacy 212. The prescription is entered by the doctors office into a card terminal 244 in communication with an optical card drive 240, which writes the prescription to the optical card 100. A drug interaction database 220 is queried by way of a wide area network (WAN) 216 to retrieve drug interaction information that is also written to the card 100. An application for interpreting, processing and presenting drug interaction information could be written to the card 100 in some embodiments. Although only one doctors office 208 and one pharmacy 212 is shown in this embodiment, the system 200 would include any number of doctors offices, pharmacies or other caregivers.

Each caregiver 208, 212 has the card terminal 244 and the optical card drive 240. The card terminal 244 is a computer that is connected to a WAN 216 that is connected to a remote drug interaction database 220. The drug interaction database 220 is maintained to include the latest available information on how mixing drugs could affect a patient. Synchronization between the card terminal 244 and the drug interaction database 220 could occur periodically or as needed by the doctor when choosing a drug or when drug interaction information is written to the card 100. When a card is read or written, the optical card drive 240 writes information to the card 100 to create an audit trail.

Various embodiments could write the whole drug interaction database 220 to the optical card 100 or just the portions relevant to the drugs taken or prescribed to the patient. Some embodiments could only write drug interaction information relevant to the patient specifically or in general. For example, the information could only take into account the patients specific treatment regiment or could include general information relevant to patients of this type. A diabetic could receive all drug interactions relevant to treatment of diabetes in one example. Other embodiments could more broadly include drug interaction information, for example, all interactions relevant to the patient's age and sex could be included without including information for the other sex or age groups.

Referring next to FIG. 2B, a block diagram of another embodiment of the multiple care giver system 200-2 is shown where a pharmacy 212 does not have access to a drug interaction database 220. In this embodiment, the pharmacy 212 does not have real-time access to any drug interaction database 220 and receives drug interaction information from the optical cards 100 that patients provide. The pharmacy has information to validate certificates on the drug interaction information received from the optical cards 100 such that authenticity can be verified. The card terminal 244 may retain the drug interaction information received from the optical cards. Where the card terminal 244 receives out of date drug interaction information from an optical card, the card terminal can use the retained drug interaction information or allow the pharmacist to choose between the two.

With reference to FIG. 2C, a block diagram of yet another embodiment of the multiple care giver system 200-3 is shown where the pharmacy 212 only has an optical card reader 246. In this embodiment, the pharmacy 212 can only read information from the optical card 100. Dispensing of the prescription is logged in the computer system of the pharmacy 212. In some embodiments, the pharmacy 212 may be able to communicate to a patient record maintained remotely that the prescription has been filled. Among other advantages, this would prevent the prescription from being filled multiple times.

Referring next to FIG. 2D, a block diagram of another embodiment of the multiple care giver system 200-4 is shown where there are two different drug interaction databases 220. In this embodiment, the doctors office 208 uses a first drug interaction database 220-1 and the pharmacy uses a second drug interaction database 220-2. These could be competing sources 220 of drug interaction information with differences in their recommendations. Interaction information from the first drug interaction database 220-1 is written to the optical card 100. The pharmacist could pick and choose between that interaction information or the interactions listed in the second drug interaction database 220-2.

With reference to FIG. 2E, a block diagram of yet another embodiment of the multiple care giver system 200-5 is shown where a doctors office 208 maintains a patient database 242. The doctors office 208 writes patient medical history, treatment regiments, therapies performed, diagnostic scans, prescribed medications, filled prescriptions, patient demographic information, and any other medical information gathered or received to the patient database 242. A portion of this information could be derived automatically from the optical card 100 where it was written by other medical providers. Some of this information can be added to the optical card 100 for possible use by other medical professionals, such as the pharmacy 212. Any information may be encrypted and could provide information for other medical professionals to verify authenticity of the information.

Referring next to FIG. 2F, a block diagram of still another embodiment of the multiple care giver system 200-6 is shown where the patient database 242 is located remotely from the medical providers. Either the doctors office 208 or the pharmacy 212 can access, modify or add information to the patient database 242 in some embodiments. Accessing the remote patient database 242 may be only to authenticate the information on the optical card 100. In some embodiments, the patient database is mirrored with the optical card 100 storing the same information or a subset of that information. One embodiment uses keys on or generated by the optical card to access the patient's record on the patient database. Without access to the optical card, the patient's record is not available to the medical professional 208, 212. Once the medical professional 208, 212 is given access, ongoing access could be given for a number of accesses, a time frame or some other definable window.

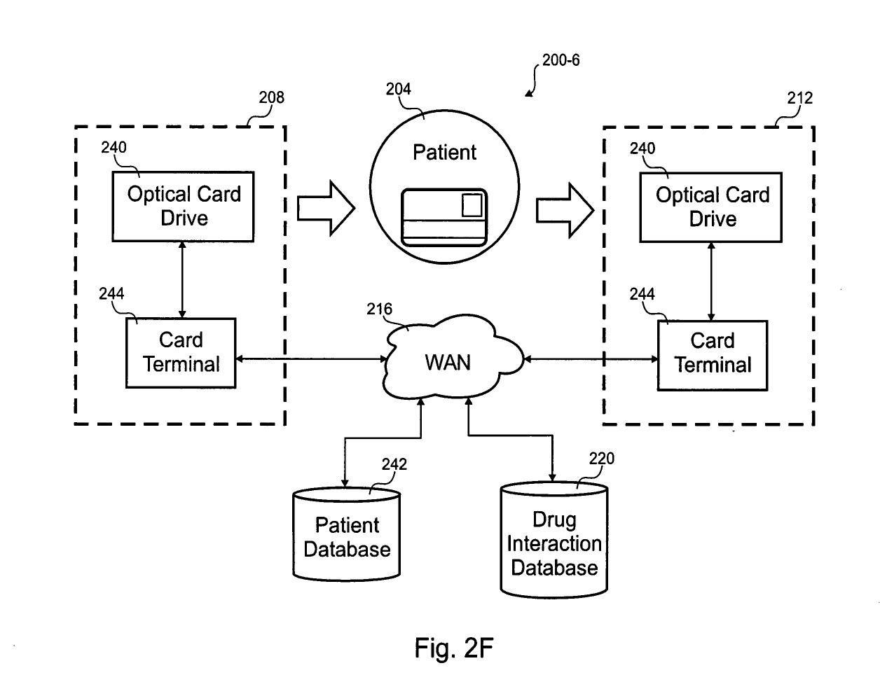

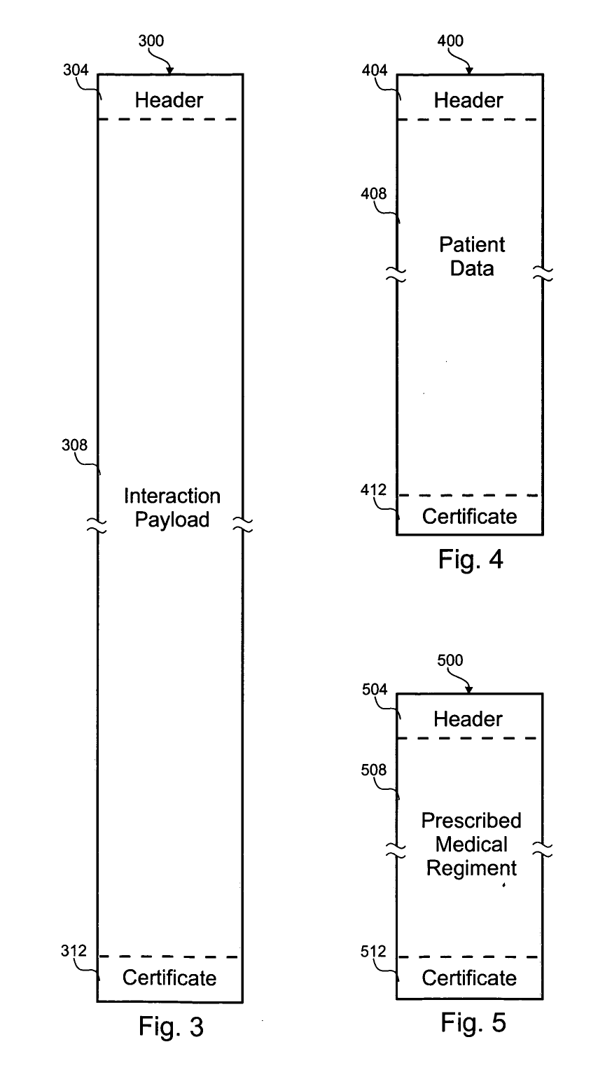

With reference to FIG. 3, a diagram of an embodiment of a treatment information datastructure 300 is shown. The treatment information datastructure 300 in this embodiment includes a header 304, an interaction payload 308 and a certificate 312. The header 304 identifies the datastructure 300 and includes a description of the datastructure 300, such as size, encryption format, certificate format, version information, etc. The certificate 312 is used to authenticate the party or parties involved in creating the interaction payload 308. The optical card drive 240 and/or card terminal 244 may have stored information to allow authenticating the certificate 312 without requesting remote information, while other embodiment connect to a WAN to check the certificate 312.

The interaction payload contains drug interaction information. A language such as XML could be used to hold the drug interaction information. An application or applet to read and display the drug interaction information could be included in the interaction payload 308 or could be in a separate datastructure. The file system of the optical card 100 could allow updating the whole interaction payload 308 or just portions as interaction information is refined. This embodiment only includes a subset of the drug interactions of the drug interaction database 220 that are relevant to the patient 204.

The interaction information could include over-the-counter medication, herbal remedies and other things consumed by the patient 204. Some embodiments could also include instructions for taking the medication, possible side-effects and other medical concerns. The pharmacy 212 could print some or all of this information out for the patient 204 for inclusion with the prescription.

The payload in this embodiment is not encrypted, but could be in other embodiments. To allow decryption, the patient or medical profession could have to provide a password or key that would unlock the payload or a portion of the payload. The key could be pre-stored in the optical card drive 240.

Referring next to FIG. 4, a diagram of an embodiment of a patient information datastructure 400 is shown. Patient information is gathered from various medical providers and others that is written to the optical card 100. A header 404 identifies the datastructure 400 and its format. The certificate is used to verify that the patient data is authentically written to the card 100. The patient data 408 could include identification information, demographic information, biometric information, billing information, medical insurance information, etc. in an XML or other format. For example, the patient data 408 could be used by the pharmacy 212 to assure the holder of the optical card 100 is the authentic holder by checking biometric information and could read medical insurance information from the card 100.

With reference to FIG. 5, a diagram of an embodiment of a regiment information datastructure 500 is shown. The optical card 100 includes treatment regiments of all kinds that might be prescribed by a medical professional. The datastructure and its format is identified by a header 504 and the certificate 512 is used to show that the datastructure is authorized. The treatment regiment 508 is in XML format, but could also include applets and software. Physical therapy, surgical operations, diets, drug therapy, etc. instructions could be included in the prescribed medical regiment 508. The medical professionals implementing the regiment could gather information on completion and patient progression that could be also added to the optical card 100 by augmenting this datastructure 500 or writing a new datastructure.

Although three types of datastructures 300, 400, 500 are described above, there could be any number of datastructures. For example, there could be a datastructure for each medical professional with their qualifications and contact information. Further, there could be datastructures for software, applets or scripts used to render, analyze or process the information on the optical card 100. Some datastructures could include electronic forms to solicit information from other medical providers and/or the patient 204. Datastructures explaining the insurance coverage could also be included such that the patient 204 and medical providers could review the policy.

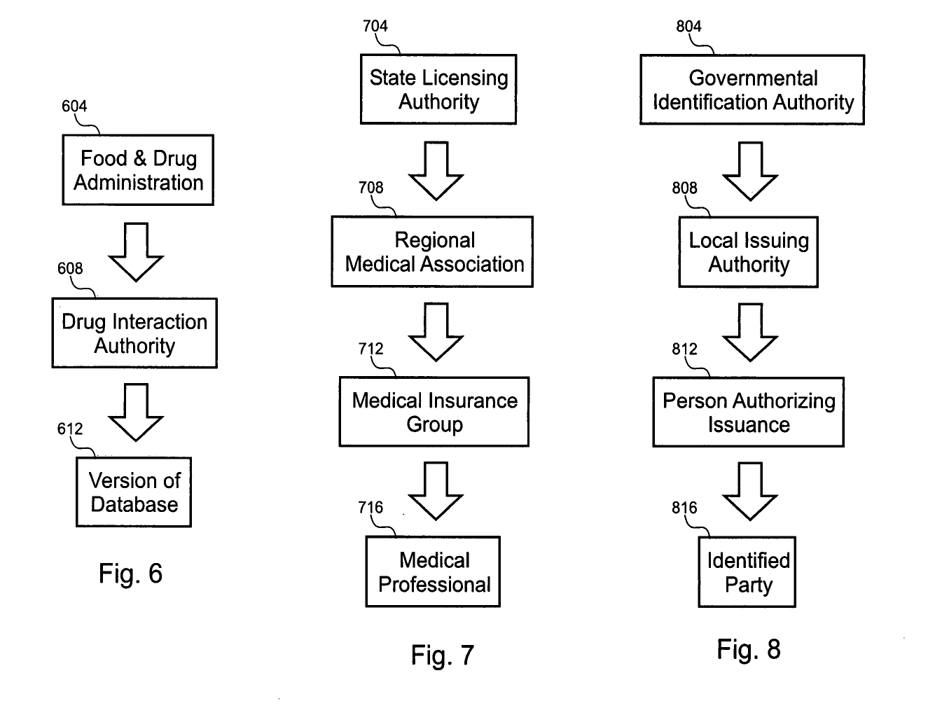

Referring next to FIG. 6, a diagram of an embodiment of a treatment information trust chain 600 is shown. A certificate for any datastructure 300, 400, 500 written to the optical card 100 can authenticate one or more parties associated with the datastructure 300, 400, 500. The treatment information trust chain 600 includes those parties that can certify the veracity of the information in the interaction payload 308.

In this embodiment, the food & drug governmental organization 604, the authority 608 developing the drug interaction information, and the release of the database version 612 all contribute to the certificate 312 portion of the datastructure 300. These could be independent certificates or a single certificate, but would allow confirming that each party believed the interaction payload 308 to be authentic. Different embodiments could have different parties authenticating a payload 308, 408, 508. Another embodiment, for example, could have certificates from the developing authority 608 and the person who inspected the quality of the database version.

Certificates can be revoked. For example, the developing authority 608 could revoke the certificate for a version of the database 612 after problems are found with that version. Revocation status could be communicated to medical providers as the card is read or periodically. The medical provider could write a datastructure to the optical card 100 of the revoked certificates that could be used by other medical providers. In some embodiments, revocation of one of the many certificates wouldn't necessarily prevent use of the payload information, but could in other embodiments.

With reference to FIG. 7, a diagram of an embodiment of a medical professional trust chain 700 is shown. This trust chain is for the medical professional involved in formulating a prescribed medical regiment 508. In this embodiment, the trust chain includes the state licensing authority 704, the regional medical association 708, the medical insurance group 712 of the patient 204, and the medical professional 716. The medical professional's ability to certify a payload could also include certifications from various schools, etc. The medical regiment could dictate who has to certify the payload 508. For example, a prescription of a narcotic may require two medical professionals to certify the prescription.

Referring next to FIG. 8, a diagram of an embodiment of an identification trust chain 800 is shown. This type of trust chain could be used to certify patient information, for example. The governmental identification authority 804, the local issuing agency 808, the person issuing the identification 812, and the identified party 816 all contribute to the certificate 412. For example, the patient 204 could become aware of identity theft and cancel their certificate to make the optical card 100 unusable. In another example, the person in the issuing authority that created the optical card had been illegally issued some optical cards and his or her certificate could be revoked to invalidate the affected patient information datastructures 400.

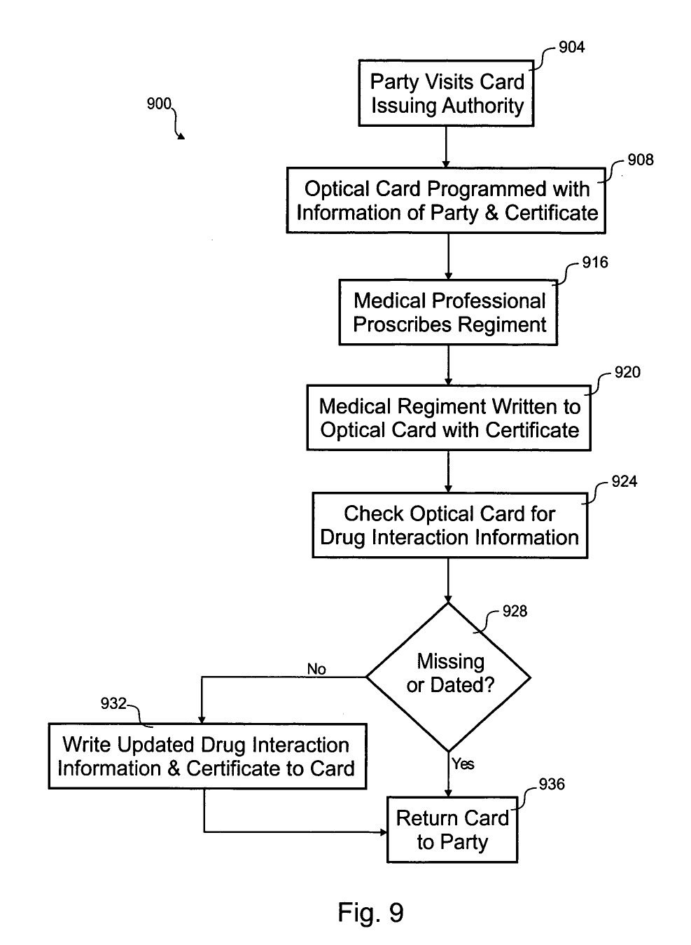

With reference to FIG. 9, a flow diagram of an embodiment of a process 900 for issuing treatment information by a first medical professional is shown. The depicted portion of the process begins in step 904 where the patient 204 is issued an optical card 100. A governmental agency or a medical professional could issue the card 100. For example, the optical card 100 could be a driving license. In step 908, a cardholder information datastructure 400 is written to the card 100 that include the appropriate certificates 412.

At some point, the patient 204 visits a medical professional and some sort of treatment is prescribed in step 916. Any type of diet, physical therapy or medication could be prescribed by the medical professional. In this embodiment, a medication is prescribed in step 916 and written to the card 100 as regiment information datastructure 500 in step 920. The patient 204 would provide the card 100 for the optical card drive 240. The medical professional would interact with software on the card terminal 244 and/or card 100 to add the medical regiment to the card 100. The medical professional may be required to provide a password and/or biometric information to authenticate their identity before the certificate 512 is written to the card 100. A datastructure with information on the medical professional may also be written to the card.

In step 924, the card 100 is checked for drug interaction information 308 related to the prescribed medical regiment 508. If it is determined that interaction information 308 is missing or out-of-date in step 928, the interaction payload 308 and certificate 312 are updated in step 932 before returning the card 100 in step 936. An update may require a query to a remote drug interaction database 220 or a local copy of that database 220. Where the interaction information 308 is already on the card and current, the card 100 is returned in step 936 without updating the interaction payload 308.

Although not shown in the flow diagram, the card issuing authority and medical professional could authenticate the patient 204. A password and/or biometric could be received by the patient 204 and checked against authenticating information in the patient data 408 or some remote database. A medical insurer may require authentication of the patient 204 to prevent disbursement of service to the wrong party.

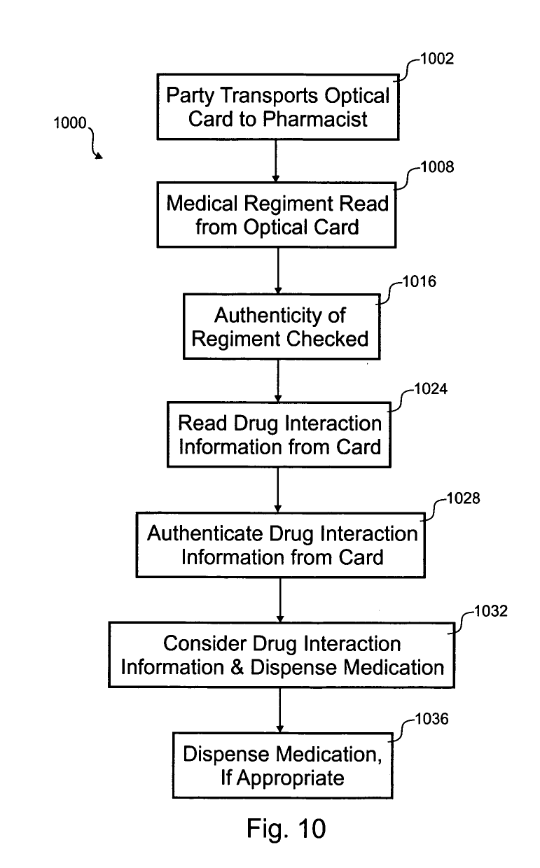

Referring next to FIG. 10, a flow diagram of an embodiment of a process 1000 for a second medical professional to use the treatment information is shown. The depicted portion of the process begins in step 1002 where the patient 204 transports the optical card to the pharmacy 212. In step 1008, the medical regiment 508 is read from the optical card 100. This may require decrypting the medical regiment 508. The authenticity of the regiment 508 is checked in step 1016 by checking the certificate 512. Where the certificate 512 cannot be validated, the pharmacy 212 would not honor the prescribed drug regiment 508. There could be a procedure where the pharmacy 212 could automatically contact the doctors office 208 to see if the prescribed regiment 508 is valid.

Before filling the prescription 508, the pharmacist would check for drug interactions. The drug interaction payload 308 is read from the card in step 1024. The certificate 312 is checked in step 1028 to authenticate the interaction payload 308. Some embodiments may validate the certificate locally or could contact remote sites with a WAN to validate. If the interaction payload 308 is valid, it is considered in step 1032. This could include checking the interaction information for all previously prescribed medication to see if the new prescription would interact. Also, the interaction information for the new medication could be checked against previously prescribed medication. Either way, the new medication can be checked to confirm that it won't interact with past prescribed medication.

The pharmacist could find that another drug interaction database 220 should be used even though the interaction payload 308 is valid. In some cases, the pharmacist could consider information from a number of databases 220 in addition to any information on the card 100. For example, the pharmacist may have a newer version of the database 220 or simply prefer an alternative database 220.

In step 1036, the medication is dispensed. The card 100 could be updated to reflect that the medication was dispensed. In some embodiments, the pharmacy 212 could communicate fulfillment of the prescription back to the patient database 242 of the doctors office. The card 100 itself could include software that would execute and report that information from the pharmacy 212. Where the pharmacy 212 did not have a WAN connection available, the software could report back at the next opportunity that the card 100 was read by a card drive 240 connected to a WAN. Any reporting across a public or private WAN could be encrypted to protect privacy of the information. The software on the card 100 could perform the encryption and/or cryptofunctions in the card drive could be used.

A number of variations and modifications of the invention can also be used. For example, the above description is primarily related to the interface between doctor and pharmacist, but the invention should not be so limited. Any time two caregivers pass a patient between them an optical card can be used to describe the treatment regiment along with information relevant to the condition. For example, a specialist for a given growth condition could write a software application to the optical card of an affected patient such that other physicians can calculate growth rates normal for that an affected patient. This extends the knowledge of the specialist to the other caregivers who also treat the patient.

While the principles of the invention have been described above in connection with specific apparatuses and methods, it is to be clearly understood that this description is made only by way of example and not as limitation on the scope of the invention.

1. A method for distributing drug interaction information for pharmacological compounds, the method comprising steps of:
receiving a request for a pharmacological compound for administration to a party;
receiving a list that includes a plurality of other pharmacological compounds associated with the party;
reading from an optical card a listing of possible drug interactions related to at least one of:
the pharmacological compound, or
the plurality of other pharmacological compounds;
determining if the pharmacological compound is contraindicated from the listing of possible drug interactions; and
printing a subset of the listing of possible drug interactions relevant to use of the pharmacological compound with the plurality of other pharmacological compounds.

2. The method for distributing drug interaction information for pharmacological compounds as recited in claim 1, further comprising steps of:
writing the list to the optical card; and
writing the listing to the optical card, wherein the optical card is written with information to uniquely identify the party that the optical card is issued to.

3. The method for distributing drug interaction information for pharmacological compounds as recited in claim 1, wherein the party is selected from a group consisting of a human and an animal.

4. The method for distributing drug interaction information for pharmacological compounds as recited in claim 1, wherein the printing step includes a step of printing to at least one of a display or a printer.

5. The method for distributing drug interaction information for pharmacological compounds as recited in claim 1, wherein the optical card is uniquely associated with the party.

6. The method for distributing drug interaction information for pharmacological compounds as recited in claim 1, further comprising a step of retrieving software instructions from the optical card, wherein at least one of the determining or printing steps is performed, at least in part, by the software instructions.

7. The method for distributing drug interaction information for pharmacological compounds as recited in claim 1, further comprising a step of determining if the listing of possible drug interactions has been superceded by a new listing of possible drug interactions.

8. The method for distributing drug interaction information for pharmacological compounds as recited in claim 1, further comprising a step of writing a new listing of possible drug interactions to the optical card if it is determined that the listing of possible drug interactions is out of date or invalid.

9. The method for distributing drug interaction information for pharmacological compounds as recited in claim 1, further comprising a step of verifying a trust chain associated with the holder of a new listing of possible drug interactions to validate the listing.

10. A computer system adapted to perform the computer-implementable method for distributing drug interaction information for pharmacological compounds of claim 1.

11. A method for distributing drug interaction information for pharmacological compounds, the method comprising steps of:
providing an optical card written with information to uniquely identify a party that the optical card is issued to;
determining the party associated with the optical card; and
writing to the optical card at least one of:
a list including a plurality of pharmacological compounds associated with the party, or
a listing of possible drug interactions for the plurality of pharmacological compounds to the optical card.

12. The method for distributing drug interaction information for pharmacological compounds as recited in claim 11, further comprising steps of:
receiving a request for a new pharmacological compound for administration to the party;
receiving the list including the plurality of other pharmacological compounds associated with the party;
reading from the optical card the listing of possible drug interactions related to the plurality of pharmacological compounds;
determining if the new pharmacological compound is contraindicated from the listing of possible drug interactions; and
printing a subset of the listing of possible drug interactions relevant to use of the new pharmacological compound with the plurality of pharmacological compounds.

13. The method for distributing drug interaction information for pharmacological compounds as recited in claim 11, wherein the party is selected from a group consisting of a human and an animal.

14. The method for distributing drug interaction information for pharmacological compounds as recited in claim 11, wherein the optical card is uniquely associated with the party.

15. The method for distributing drug interaction information for pharmacological compounds as recited in claim 11, further comprising a step of writing software instructions to the optical card, wherein the software can process at least one of the list or the listing.

16. The method for distributing drug interaction information for pharmacological compounds as recited in claim 11, further comprising a step of writing a certificate that can be used in verifying a trust chain associated with listing.

17. An optical prescription card for use in distributing drug interaction information for pharmacological compounds, the optical prescription card comprising:
party information that is unique to a party who is issued the optical prescription card;
data optically written to the optical prescription card, wherein the data includes at least one of:
a list including a plurality of pharmacological compounds associated with the party, or
a listing including possible drug interactions for the plurality of pharmacological compounds.

18. The optical prescription card for use in distributing drug interaction information for pharmacological compounds as recited in claim 17, wherein the party information does not provide any identity or demographic information to unauthorized persons who access the optical prescription card.

19. The optical prescription card for use in distributing drug interaction information for pharmacological compounds as recited in claim 17, wherein the optical prescription card optically stores at least one megabyte of data.

20. The optical prescription card for use in distributing drug interaction information for pharmacological compounds as recited in claim 17, wherein the optical prescription card is uniquely associated with the party.

21. The optical prescription card for use in distributing drug interaction information for pharmacological compounds as recited in claim 17, further comprising software instructions that are used in processing at least one of the list or the listing.

22. The optical prescription card for use in distributing drug interaction information for pharmacological compounds as recited in claim 17, wherein authenticity of at least one of the list or the listing is verifiable.
